(19) United States
(12) Patent Application Publication
(10) Pub. No.: US 2007/0200513 A1
(43) Pub. Date: Aug. 30, 2007

(54) DRIVE DEVICE OF COLOR LED BACKLIGHT

(75) Inventors: Chang Woo Ha, Kyungki-Do (KR); Byoung Own Min, Kyungki-Do (KR); Jung Chul Gong, Seoul (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/566,565

(22) Filed: Dec. 4, 2006

(30) Foreign Application Priority Data
Feb. 28, 2006 (KR) 10-2006-0019405

(51) Int. Cl. H05B 39/04

(52) U.S. Cl. 315/309

(57) ABSTRACT

Disclosed herein is a drive device of a color light emitting diode (LED) backlight, which is capable of uniformly controlling an optical output of an LED regardless of a variation in an ambient temperature and easily changing characteristic data (by referring to a lookup table).

The drive device for driving the color LED backlight which includes a plurality of color LED arrays includes a voltage detecting unit for detecting a voltage applied to the color LED backlight, a temperature detecting unit for detecting a temperature of the color LED backlight, a control unit for controlling driving currents which respectively flow in the color LED arrays of the color LED backlight according to the temperature detected by the temperature detecting unit and the voltage detected by the voltage detecting unit, by referring to previously set driving current values, and a multi-channel current source for adjusting amounts of the driving currents which respectively flow in the color LED arrays of the color LED backlight, by the driving current control of the control unit.

### RELATED APPLICATIONS

The present application is based on, and claims priority from, Korean Application Number 2006-19405, filed Feb. 28, 2006, the disclosure of which is incorporated by reference herein in its entirety.

### BACKGROUND OF THE INVENTION

1. Field of the Invention

The present invention relates to a drive device of a color light emitting diode (LED) used in a display apparatus, and more particularly, to a drive device of a LED backlight with high production efficiency, which is capable of uniformly controlling an optical output of an LED regardless of a variation in an ambient temperature and changing the characteristic data without an additional external circuit upon replacement of the LED, by controlling the optical output amounts of color LED arrays according to the ambient temperature of the LED or a detection voltage of the LED and easily changing characteristic data upon replacement of the LED.

2. Description of the Related Art

In general, at least two hundred eighty million display products are being demanded each year in a mobile display market including mobile phones, MP3 players, personal media players (PMP), automotive navigators, mobile or vehicle DVD/AV systems, and laptop computers. Most of the mobile display market is occupied by a thin film transistor-liquid crystal display (TFT-LCD) technology. Competition among enterprises for improvement of price and performance of the TFT-LCD is becoming severe.

Since the TFT is not self-luminous, the TFT LCD requires an additional light emitting element such as a backlight unit (BLU). The BLU can be embodied by various technologies. Most of LCD-BLUs which are commercially available use a cold cathode fluorescent lamp (CCFL). The CCFL has advantages such as high brightness, low manufacturing cost, a simple driving circuit and a thin tube shape. However, since the CCFL is weak against external impact, a mobile TFT-LCD having a size of about 5 inches or less uses a white LED.

FIG. 1 is a block diagram showing the configuration of a conventional drive device of a white LED backlight.

The conventional drive device 10 of the white LED backlight shown in FIG. 1 drives a white LED backlight 20 and includes a voltage detecting unit 11 for detecting the voltage of the white LED backlight 20, a control unit 12 for controlling driving current according to a difference between the voltage detected by the voltage detecting unit 11 and a brightness adjustment voltage, a burst mode dimming unit 13 for adjusting a driving current amount using a burst mode dimming method based on a dimming voltage Vdim, and a current source 14 for adjusting the amount of driving current Id flowing in the white LED backlight 20 according to the adjustment of the driving current amount of the burst mode dimming unit 13.

Each LED of the white LED backlight 20 consumes driving current of about 10 mA and a driving voltage of about 1.8 to 3 V. The conventional drive device of the white LED backlight properly adjusts the driving current amount of the white LED using a method for controlling the current amount of the white LED. More particularly, the control unit 12 can provide a control signal to the current source 14 to adjust brightness in a burst mode.

In the CCFL or the white LED, since color reproducibility falls to about 70 to 80% of the NTSC standard, it is impossible to accomplish accurate color reproduction. In order to solve such a problem, research for implementing color reproducibility of approximately at least 90% using a color light source is actively ongoing. Now, color LEDs (RGB LEDs) are beginning to be commercialized in a liquid crystal display-high definition television (LCD-HDTV) market and an expert LCD monitor market and an application thereof is gradually expanded as a technology develops and production amount increases.

However, in the conventional drive device of the white LED backlight, due to LED characteristics, the color LEDs (RGB LEDs) are different in a driving voltage, that is, the level of a forward voltage Vf, and optical output efficiency. Accordingly, a function for adjusting the forward voltage Vf is required. When the LEDs are connected in series, the number of the LEDs varies or a difference between the forward voltages Vf increases.

In addition, since the color LEDs are sensitive in a temperature, there is need for a technology for correcting a variation in light efficiency, a variation in current amount and characteristic difference among the color LEDs due to a variation in temperature.

### SUMMARY OF THE INVENTION

Therefore, the present invention has been made in view of the above problems, and it is an object of the present invention to provide a drive device of a color LED backlight with high production efficiency, which is capable of uniformly controlling an optical output of an LED regardless of a variation in an ambient temperature and changing the characteristic data without an additional external circuit upon replacement of the LED, by controlling the optical output amounts of color LED arrays according to the ambient temperature of the LED or a detection voltage of the LED and easily changing characteristic data (by referring to a lookup table) upon replacement of the LED.

In accordance with the present invention, there is provided a drive device for driving a color light emitting diode (LED) backlight including a plurality of color LED arrays, comprising: a voltage detecting unit for detecting a voltage applied to the color LED backlight; a temperature detecting unit for detecting a temperature of the color LED backlight; a control unit for controlling driving currents which respectively flow in the color LED arrays of the color LED backlight according to the temperature detected by the temperature detecting unit and the voltage detected by the voltage detecting unit, by referring to previously set driving current values; and a multi-channel current source for adjusting amounts of the driving currents which respectively flow in the color LED arrays of the color LED backlight, by the driving current control of the control unit.

The control unit may comprise a lookup table in which the driving current values are previously set for each temperature and voltage; a main controller for uniformly controlling light efficiencies of the color LED arrays of the color LED backlight according to the temperature detected by the temperature detecting unit and the voltage detected by the voltage detecting unit by referring to the driving current values set in the lookup table; and a current controller for controlling the driving currents through the multi-channel current source by the control of the main controller.

The plurality of color LED arrays of the color LED backlight may include first, second and third color LED arrays; and the multi-channel current source may comprise a DA converter for converting a driving current control signal of the current controller of the control unit into an analog control signal; and first, second and third current sources for adjusting the amounts of first, second and third driving currents which respectively flow in the first, second and third color LED arrays, according to the analog control signal from the DA converter.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a conventional drive device of a white LED backlight;

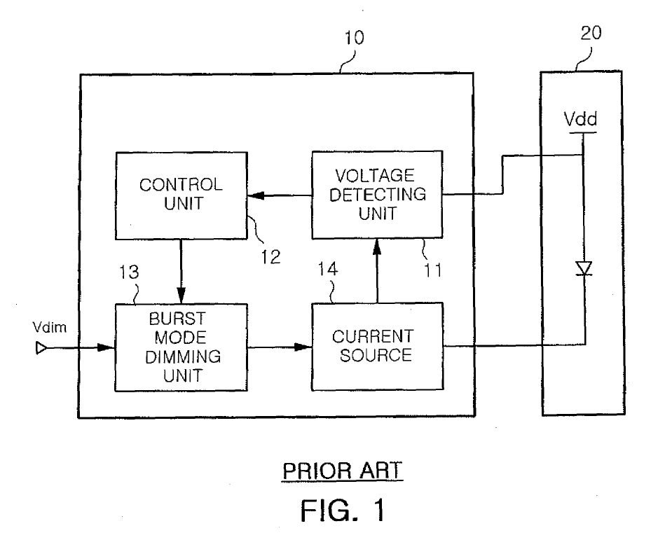

FIG. 2 is a block diagram showing the configuration of a drive device of a color LED backlight according to the present invention; and

FIG. 3 is a flowchart illustrating the operation of the drive device of the color LED backlight according to the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings.

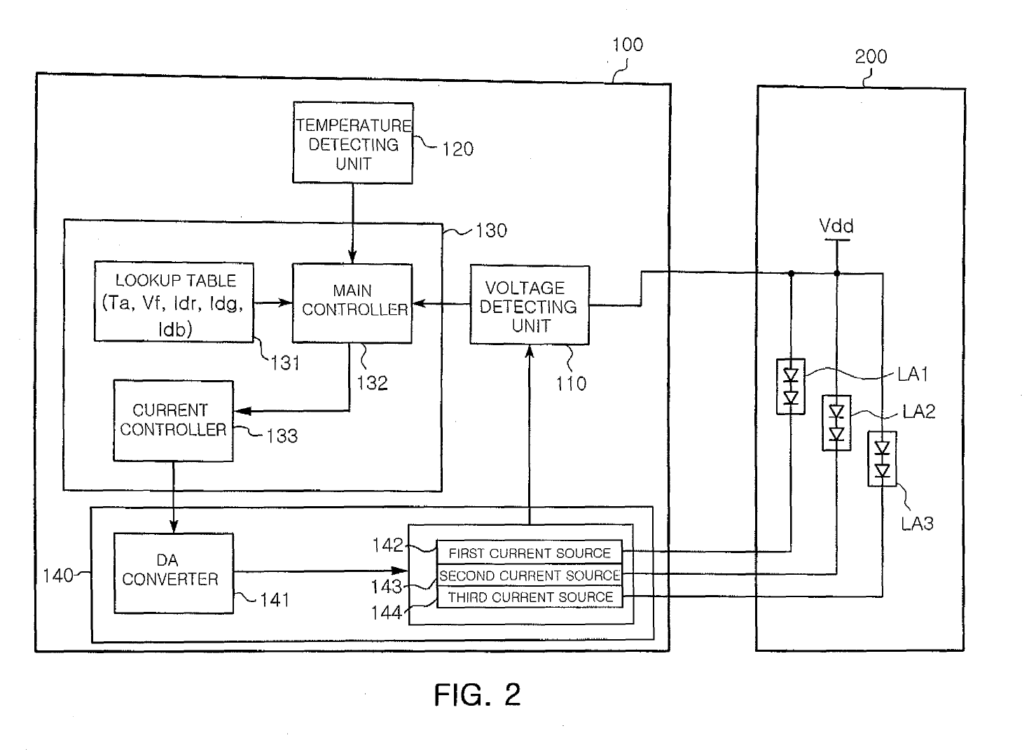

FIG. 2 is a block diagram showing the configuration of a drive device of a color LED backlight according to the present invention.

Referring to FIG. 2, the drive device of the color LED backlight according to the present invention drives a color LED backlight 200 including a plurality of color LED arrays LA1, LA2 and LA3 and includes a voltage detecting unit 110, a temperature detecting unit 120, a control unit 130 and a multi-channel current source 140.

The voltage detecting unit 110 detects a voltage applied to the white LED backlight 200, that is, a forward voltage.

The temperature detecting unit 120 detects the temperature of the color LED backlight 200. Since light efficiencies of color LEDs included in the color LED backlight 200 vary depending on the temperature and the forward voltage, the current temperature needs be detected in order to uniformly control the light efficiency.

The control unit 130 controls driving current flowing in each color LED array of the color LED backlight 200 by referring to a previously set driving current value, according to the temperature detected by the temperature detecting unit 120 and the voltage detected by the voltage detecting unit 110.

The multi-channel current source 140 adjusts the amount of the driving current flowing in each color LED array of the color LED backlight 200 by the driving current control of the control unit 130.

More specifically, the control unit 130 includes a lookup table 131 in which driving current values are previously set for each temperature and voltage, a controller 132 which uniformly controls light efficiency of each color LED array of the color LED backlight 200 by referring to a driving current voltage in lookup table 131, according to the temperature detected by the temperature detecting unit 120 and the voltage detected by the voltage detecting unit 110, and a current controller 133 which controls the driving current through the multi-channel current source 140 by the control of the main controller 132.

In the lookup table, since there are various kinds of color LED and many producers and the characteristics of the color LED vary depending on the kind of the color LED and the producer, the light efficiencies of the color LEDs produced by different producers need be adjusted. Accordingly, when the forward voltage Vf and driving current Id are fixed and the kind of the LED and the producer are different, the fixed values of a driving circuit must be changed by an external circuit.

However, in this case, an additional I/O interface for changing the values of the driving circuit and an additional circuit for fixing the externally changed value are further included. In consideration of such circumferences, in the present invention, an additional built-in storage device for storing a light efficiency parameter lookup table is included.

Each color LED has the light efficiency parameter lookup table for each kind of the color LED or producer. When the LED is replaced, only data need be changed by software. According to the present invention, since an additional external circuit is not required and the data is easily changed by software, it is possible to increase production efficiency.

The lookup table, for example, includes an address of a memory, a vendor code of a vendor, a LED code of color (RGB) information, efficiency, driving current Id, a forward voltage Vf and a temperature Ta.

Since the driving current having maximum efficiency can be obtained by referring to the temperature and the forward voltage set in the lookup table, it is possible to control the drive of the color LEDs with maximum efficiency according to the current temperature and forward voltage.

The color LED backlight 200 includes first, second and third color LED arrays LA1, LA2 and LA3. The multi-channel current source 140 includes a DA converter 141 for converting a driving current control signal of the current controller 133 of the control unit 130 into an analog control signal and first, second and third current sources 142, 143 and 144 which adjust the amount of first, second and third driving current Idr, Idg and Idb which respectively flow in the first, second and third color LED arrays LA1, LA2 and LA3, according to the analog control signal from the DA converter 142.

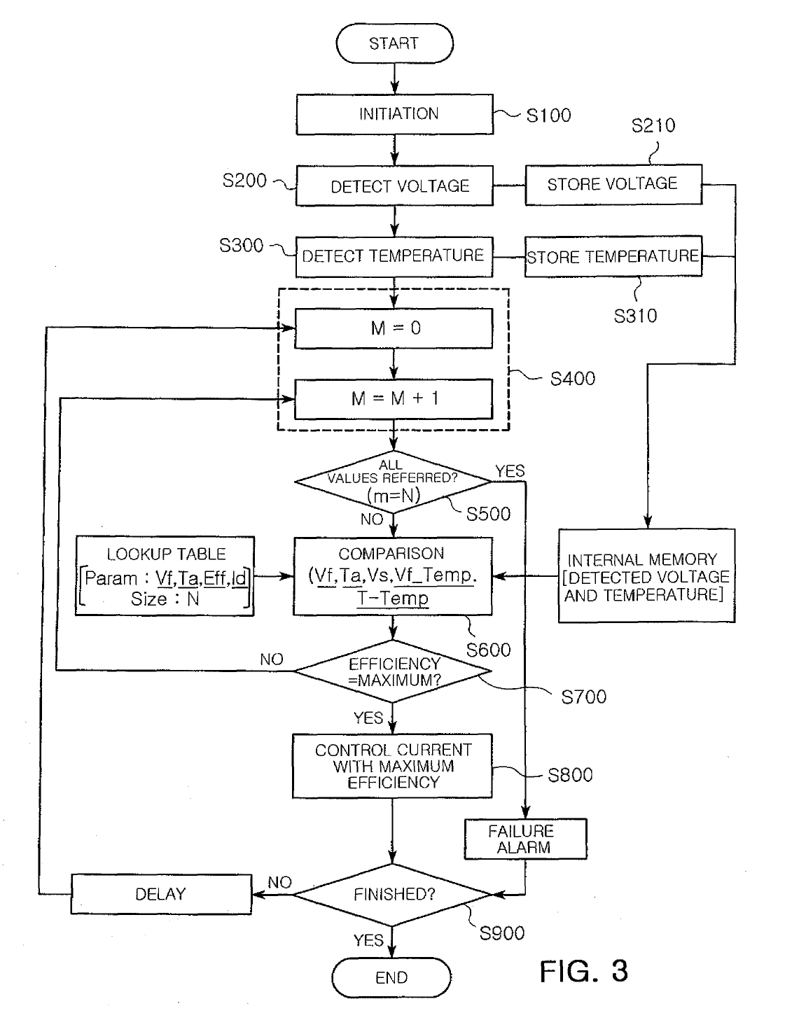

FIG. 3 is a flowchart illustrating the operation of the drive device of the color LED backlight according to the present invention. In FIG. 3, at step S100, the drive device of the color LED backlight according to the present invention is initiated. At step S200, the voltages applied to the color LEDs, that is, the forward voltages are detected. At step S300, the temperatures of the color LEDs are detected. At step S400, the number referring to the values set in the lookup table is counted. At step S500, it is determined whether all the values set in the lookup table are referred. At step S600, a set value corresponding to the detected values is retrieved from the lookup table. At step S700, it is determined whether the retrieved set value has maximum efficiency. At step S800, current is controlled by the set value having the maximum efficiency. At step S900, it is determined whether the driving operation is finished.

Hereinafter, the operation and the effect of the present invention will be described in detail with reference to the attached drawings.

Referring to FIGS. 2 and 3, the operation of the drive device of the color LED backlight according to the present invention will be described. First, in FIG. 2, the drive device of the color LED backlight according to the present invention starts up (S100). The voltage applied to the white LED backlight 200 is detected by voltage detecting unit 110, and the detected voltage is stored in an internal memory of the control unit 130 (S200 and S210 of FIG. 3). The temperature of the color LED backlight 200 is detected by temperature detecting unit 120 and the detected temperature is stored in the internal memory of the control unit 130 (S300 and S310 of FIG. 3).

Next, the control unit 130 controls the driving current which flows in each of the color LED arrays LA1, LA2 and LA3 of the color LED backlight 200 according to the temperature detected by the temperature detecting unit 120 and the voltage detected by the voltage detecting unit 110, by referring to the previously set driving current value. Then, the multi-channel current source 140 adjusts the amounts of driving currents Idr, Idg and Idb, which respectively flow in the color LED arrays LA1, LA2 and LA3 of the color LED backlight 200, by the driving current control of the control unit 130 (S400 to S900 of FIG. 3).

Now, this operation will be described in detail.

In the lookup table 131 of the control unit 130, the driving current values are previously set for each temperature and voltage, as described above. The main controller 132 of the control unit 130 controls the light efficiency of each color LED array of the color LED backlight 200 according to the temperature detected by the temperature detecting unit 120 and the voltage detected by the voltage detecting unit 110, by referring to all the driving current values set in the lookup table 131.

That is, the main controller 132 compares the temperature detected by the temperature detecting unit 120 and the voltage detected by the voltage detecting unit 110 with the set values stored in the lookup table 131 and retrieves the set value corresponding to the temperature detected by the temperature detecting unit 120 and the voltage detected by the voltage detecting unit 110 (S400 to S600 of FIG. 3).

The main controller 132 determines whether the retrieved set value has the maximum efficiency. Then, the current controller 133 of the control unit 130 controls the driving currents through the multi-channel current source 140 by the control of the main controller 132 (S700 of FIG. 3).

Next, the DA converter 141 of the multi-channel current source 140 converts the driving current control signal of the current controller 133 of the control unit 130 into the analog control signal and outputs the analog control signal to the first, second and third current sources 142, 143 and 144. The color LED backlight 200 may include the first, second and third color LED arrays LA1, LA2 and LA3. At this time, the first, second and third current sources 142, 143 and 144 adjust the amounts of the first, second and third driving currents Idr, Idg and Idb which respectively flow in the first, second and third color LED arrays LA1, LA2 and LA3, according to the analog control signal outputted from the DA converter 141 (S800 and S900 of FIG. 3).

It is possible to uniformly control the light amounts of the plurality of LEDs by individually controlling the plurality of color LED arrays based on the current temperature.

As described above, in the present invention, the forward bias voltage and the current temperature are monitored in real time by forward voltage Vf sensing and temperature sensing, and the lookup table in which the forward voltage Vf, the driving current Id, the temperature and the light amount of each color LED are set is stored in the memory block, the monitored values and the information of the lookup table are compared with each other in the built-in control unit, the control value of the driving current Id is sent to the current control block, the control signal generated at the current control unit is converted into the analog control signal by DA conversion, and the multi-channel current source receives the analog control signal and adjusts the current amounts of the color LED arrays in real time, thereby always maintaining optimal uniform light amounts.

According to the present invention, color LEDs can optimally output the uniform light amounts although an ambient temperature varies or an external circuit is replaced.

When the drive device according to the present invention includes a DC-DC converter for supplying the forward voltage, the forward voltage bias of the LED can increase by increasing the forward voltage Vf. More particularly, in a mobile device, a power supply voltage is restricted by a battery and a constant voltage source having a 3.6 V or 2.8 V or less must be used. Accordingly, when the forward voltage Vf of the LED is at least 2 V and at least two LEDs are connected in series, the DC-DC converter for supplying the forward voltage may be added.

The optical outputs of the color LEDs do not have a linear characteristic with respect to the current amount. Furthermore, although a linear characteristic period exists, the linear characteristic period is very short. Accordingly, when the brightness is adjusted by the current amount, a control circuit may become complicated.

The current amounts of the color LEDs are controlled to output the light having maximum efficiency. When burst mode dimming is performed, the brightness can be linearly controlled and the brightness can be precisely adjusted from 0% to 100%.

As described above, according to the present invention, the optical output amounts of the color LEDs can be uniformly controlled independent of a variation in temperature, an optical output ratio of the color LEDs can be uniformly maintained, and the optical output ratio is uniform even when the brightnesses of the colors LEDs vary.

The temperature characteristic and the optical output characteristic vary depending on the kind of the color LED and a producer. Accordingly, when information on the kind of the color LED and the producer is stored in a lookup table by software, an external element or circuit corresponding to a variation in circuit structure or characteristic value is not required when an LED is replaced.

According to the present invention, there is provided a drive device of a color LED backlight with high production efficiency, which is capable of uniformly controlling an optical output of an LED regardless of a variation in an ambient temperature and changing the characteristic data without an additional external circuit upon replacement of the LED, by controlling the optical output amounts of color LED arrays according to the ambient temperature of the LED or a detection voltage of the LED and easily changing characteristic data (by referring to a lookup table) upon replacement of the LED.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A drive device for driving a color light emitting diode (LED) backlight including a plurality of color LED arrays, comprising:
a voltage detecting unit for detecting a voltage applied to the color LED backlight;
a temperature detecting unit for detecting a temperature of the color LED backlight;
a control unit for controlling driving currents which respectively flow in the color LED arrays of the color LED backlight according to the temperature detected by the temperature detecting unit and the voltage detected by the voltage detecting unit, by referring to previously set driving current values; and
a multi-channel current source for adjusting amounts of the driving currents which respectively flow in the color LED arrays of the color LED backlight, by the driving current control of the control unit.

2. The device according to claim 1, wherein the control unit comprises:
a lookup table in which the driving current values are previously set for each temperature and voltage;
a main controller for uniformly controlling light efficiencies of the color LED arrays of the color LED backlight according to the temperature detected by the temperature detecting unit and the voltage detected by the voltage detecting unit by referring to the driving current values set in the lookup table; and
a current controller for controlling the driving currents through the multi-channel current source by the control of the main controller.

3. The device according to claim 2, wherein:
the plurality of color LED arrays of the color LED backlight include first, second and third color LED arrays; and
the multi-channel current source comprises
a DA converter for converting a driving current control signal of the current controller of the control unit into an analog control signal; and
first, second and third current sources for adjusting the amounts of first, second and third driving currents which respectively flow in the first, second and third color LED arrays, according to the analog control signal from the DA converter.
